(19) United States
(12) Patent Application Publication
(10) Pub. No.: US 2012/0147179 A1
(43) Pub. Date: Jun. 14, 2012

(54) METHOD AND SYSTEM FOR PROVIDING INTELLIGENT ACCESS MONITORING, INTELLIGENT ACCESS MONITORING APPARATUS

(75) Inventors: Geon Lyang KIM, Daejeon (KR); Beom Hwan CHANG, Daejeon (KR)

(73) Assignee: Electronics and Telecommunications Research Institute, Daejeon (KR)

(21) Appl. No.: 13/314,421

(22) Filed: Dec. 8, 2011

(30) Foreign Application Priority Data
Dec. 13, 2010 (KR) 10-2010-0127130

(51) Int. Cl. H04N 7/18

(52) U.S. Cl. 348/143; 348/E07.085

(57) ABSTRACT

A system for intelligent access monitoring includes: an access control apparatus for detecting and managing an access of a visitor, the access control apparatus generating a access event information when detecting the access; a video security apparatus for managing an video information and a location information of the visitor; and an access monitoring apparatus for receiving the access event information, the video information and the location information via a network, generating a access monitoring profile information based on the access event information, and generating a mapping information where the access monitoring profile information is mapped with the video information and the location information.

### CROSS-REFERENCE(S) TO RELATED APPLICATION(S)

The present invention claims priority of Korean Patent Application No. 10-2010-0127130, filed on Dec. 13, 2010, which is incorporated herein by reference.

### FIELD OF THE INVENTION

The present invention relates to a system for providing intelligent access monitoring; and, more particularly, to a method and a system for providing intelligent access monitoring and an intelligent access monitoring apparatus which are suitable for providing an additional information of a visitor which is collected and analyzed through a web by using a data profiling technique when monitoring the access of the visitor by a video security system.

### BACKGROUND OF THE INVENTION

Since the 911 terror occurred on Sep. 11, 2001, investment has been made in a territory security technology for the safety of an individual and the public around the world. In addition, a demand for a video security solution is growing rapidly since 2002 and the main market of the video security solution, i.e., a closed circuit television (CCTV) and a digital video recorder (DVR) is also growing rapidly.

Video information collected from the CCTV is transmitted to a control center and a manager observes the video information directly through a monitor. However, when the manager observes two monitors at the same time, the direct observation and analysis of the video information has limitations. For example, after 22 minutes elapses, the 95% of the video information can be missed by the manager.

Because of the limitation of the observation of the manager, the development of a video security system helping the video analysis of the manager, e.g., a motion detecting function for detecting a moving object automatically through a camera and a object detecting and chasing function is proceeding. The video security system includes functions of detecting, categorizing, chasing the moving object, and recognizing a behavior based on an automatic video analysis.

Meanwhile, the number of users using a web is being increased and the web constituting an internet is also being increased largely due to the vitalization of the internet. However, the technology of saving time for searching information which the user want to find out or helping the user to find the information from a lot of web pages is required since the information is an extremely small part of a lot of web pages.

Thus, a web recommendation agent technology recommending information or a product which the user is interested in is being developed. However, satisfying result for the user is not being made.

### SUMMARY OF THE INVENTION

In view of the above, present invention provides an intelligent access monitoring technology which can raise the level of security by collecting and analyzing additional network information for a visitor through a web with access event information of the visitor entering a specific facility, e.g., smartcard tag information and providing the profile information of the visitor.

Further, the present invention provides an intelligent access monitoring technology which makes possible intuitive recognition of security state by mapping the video information of the visitor with the 3D building using the profile information and the location information of a video security system.

In accordance with a first aspect of the present invention, there is provided a system for intelligent access monitoring, including:

an access control apparatus for detecting and managing an access of a visitor, the access control apparatus generating a access event information when detecting the access;

a video security apparatus for managing an video information and a location information of the visitor; and

an access monitoring apparatus for receiving the access event information, the video information and the location information via a network, generating a access monitoring profile information based on the access event information, and generating a mapping information where the access monitoring profile information is mapped with the video information and the location information.

In accordance with a second aspect of the present invention, there is provided an intelligent access monitoring apparatus, including:

an access event collecting unit for receiving an access event information from an access control apparatus via a network;

a profile managing unit for generating a keyword for a network information search, categorizing and grouping the network information repeatedly according to a result of the network information search;

an information searching unit for searching for the network information by using the keyword generated by the profiling managing unit;

a preprocessing unit for performing a preprocessing for extracting an information relating to a visitor information from the network information which is searched for by the information searching unit and providing the profile managing unit with a result of the preprocessing; and

an access monitoring unit for generating an access monitoring profile information corresponding to the visitor information filtered by the profile managing unit and providing a mapping information where the generated access monitoring profile information is mapped with the video information and the location information of a video security apparatus.

In accordance with a third aspect of the present invention, there is provided a method for providing an intelligent access monitoring, including:

receiving an access event information from an access control apparatus;

receiving a video information and a location information of a visitor form a video security apparatus;

generating an access monitoring profile information based on the received access event information; and

providing a mapping information where the generated access monitoring information is mapped with the received video information and location information.

### BRIEF DESCRIPTION OF THE DRAWINGS

The objects and features of the present invention will become apparent from the following description of embodiments, given in conjunction with the accompanying drawings, in which:

FIG. 1 is a schematic block diagram showing a system for providing intelligent access monitoring in accordance with an embodiment of the present invention.

FIG. 2 shows a specific block diagram of an intelligent access monitoring apparatus an access monitoring apparatus of FIG. 1 in accordance with an embodiment of the present invention.

FIG. 3 illustrates a specific block diagram of a profile managing unit of the profile managing unit of FIG. 2.

FIG. 4 depicts a specific block diagram of a preprocessing unit of the profile managing unit of FIG. 2.

FIG. 5 offers an exemplary flow chart of a method for intelligent access monitoring in accordance with an embodiment of the present invention.

### DETAILED DESCRIPTION OF THE EMBODIMENTS

Hereinafter, embodiments of the present invention will be described with reference to the accompanying drawings which form a part hereof.

The present invention relates to a system for providing intelligent access monitoring using data profiling technology. The system can provide additional information which is collected and analyzed on a web when monitoring access of a visitor by a video security system.

Particularly, the system for providing intelligent access monitoring can receive an access event generated by an access control apparatus and generate a profile for the visitor based on the access event. Then, the system can provide a manager with the profile mapped with location information and video information of the video security system.

A data profiling technology using a data mining method can be applied in order to provide the additional information of the visitor.

The present invention is a convergence technology between a video security technology and an information searching technology. The conventional video security system cannot collect additional information except information provided from a video because the conventional video security system is a technology analyzing the video. However, the present invention can upgrade a security level by providing the additional information obtained by analyzing data collected from an internet.

FIG. 1 is a schematic block diagram showing a system for providing intelligent access monitoring in accordance with an embodiment of the present invention.

The system can include an access control apparatus 10, a video security apparatus 12, a network 1, an access monitoring apparatus 100 and an access monitoring database 102.

As shown in FIG. 1, the access control apparatus 10 monitors and manages the access of the visitor. For example, the access control apparatus 10 can include a smart card system, a door opening/closing system and a fingerprint/iris/face recognition system etc. The access control apparatus 10 can generate access event information, e.g., smart card tag information when access behavior of the visitor exists.

The video security apparatus 12 can include a closed circuit television (CCTV), an infrared camera and a digital video recorder (DVR) etc. The video security apparatus 12 can take moving images for the visitor and store the moving images temporally. The video information and the location information of the visitor can be managed by the video security apparatus 12 and the managed video information and location information can be provided to the access monitoring apparatus 100.

The network 1 can provide an access environment via which the access monitoring apparatus 100 communicates with the access control apparatus 10 and/or the video security apparatus 12. The network 1 can include a wideband network and a local area network etc.

Here, the wideband network can include a wideband wireless network and a wideband wired network.

The wideband wireless network includes a base station and a base station controller. The wideband wireless network can support a synchronous system and an asynchronous system. In case of the synchronous system, the base station can be a base transceiver station (BTS) and the base station controller can be a base station controller (BSC). In case of the asynchronous system, the base station can be a Node B and the base station controller can be radio network controller (RNC). The wideband wireless network is not limited to the above. The wideband wireless network can include a global system for mobile communication (GSM) network and networks of all mobile communication systems to be implemented hereafter other than a CDMA network.

The wideband wired network as, e.g., an Internet can mean a worldwide open computer network structure providing a TCP/IP protocol and various services which exist on an upper layer of the TCT/IP protocol, e.g., a hypertext transfer protocol (HTTP), a file transfer protocol (FTP), a domain name system (DNS), a simple mail transfer protocol (SMTP), a simple network management protocol (SNMP), a network file service (NFS) and a network information service (NIS).

The local area network can include a local area wired network and a local area wireless network.

The local area wired network as e.g., local area network (LAN) can provide a local area wired communication environment via which the access monitoring apparatus 100, the access control apparatus 10 and the video security apparatus 12 communicate with each other.

The local area wireless network can includes a local area communication environment such as a Wi-Fi via which the access monitoring apparatus 100, the access control apparatus 10 and the video security apparatus 12 communicate with each other.

The access monitoring apparatus 100 of the embodiment of the present invention can receive the access event information from the access control apparatus 10 via the network 1 and receive the video information and the location information of the visitor from the video security apparatus 12 via the network 1. The access monitoring apparatus 100 can generate access monitoring profile information for the visitor based on the access event information received from the access control apparatus 10 and can perform mapping the profile information with the video information and the location information from the video security apparatus 12. The mapping result by the access monitoring apparatus 100 can be displayed on a terminal of a manager (not shown in the Figs). Here, the mapping result can be mapping information between the profile information and the video information by using the location information. Such mapping information can be processed in order to be expressed on 3D building. At this time, a data profiling technology using data mining method collecting and analyzing network information through a web etc. can be applied to the described profile information.

The access monitoring database 102 can be managed by the access monitoring apparatus 100. The access event information from the access control apparatus 10 and the video information and the location information from the video security apparatus 12 can be stored temporally.

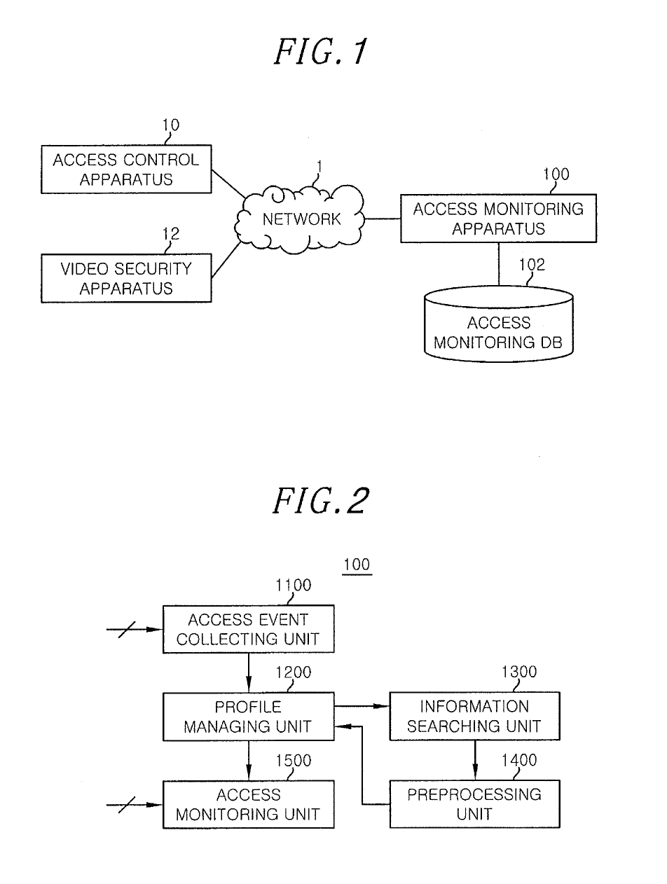

FIG. 2 shows a specific block diagram of an access monitoring apparatus of FIG. 1.

As shown in FIG. 1, the access monitoring apparatus 100 for intelligent access monitoring according to the embodiment of the present invention can include an access event collecting unit 1100, a profile managing unit 1200, an information searching unit 1300, a preprocessing unit 1400 and an access monitoring unit 1500 etc.

The access event collecting unit 1100 can collect the access event information from the access control apparatus 10, store the access event information in the access monitoring database 102 and call the profile managing unit 1200 described below as necessary.

The profile managing unit 1200 can generate a keyword for searching for network information. For example, the profile managing unit 1200 can generate a keyword for searching the network information based on the access event information from the access control apparatus 10. The keyword can be, e.g., a keyword based on metadata.

In addition, the profile managing unit 1200 can categorize and group network information repeatedly according to the preprocessing result from the preprocessing unit 1400 described below. Information of people having the same name as the visitor can be grouped by repeat categorization and grouping process and the visitor information can be filtered. Here, the network information can include, e.g., webpage information relating to the keyword.

The information searching unit 1300 can search for the network information (the webpage information) by using the keyword and provide the preprocessing unit 1400 with the result.

The preprocessing unit 1400 can perform a preprocess for extracting information relating to the visitor information from the network information which is searched for by the information searching unit 1300 and provide the profile managing unit 1200 with the result of the preprocess.

The access monitoring unit 1500 can generate access monitoring profile information corresponding to the visitor information filtered by the profile management unit 1200 and provide mapping information which is made by mapping the generated access monitoring profile information with the location information and the video information of the video security apparatus 12.

The mapping information can be processed to be displayed on a 3D building by the manager terminal.

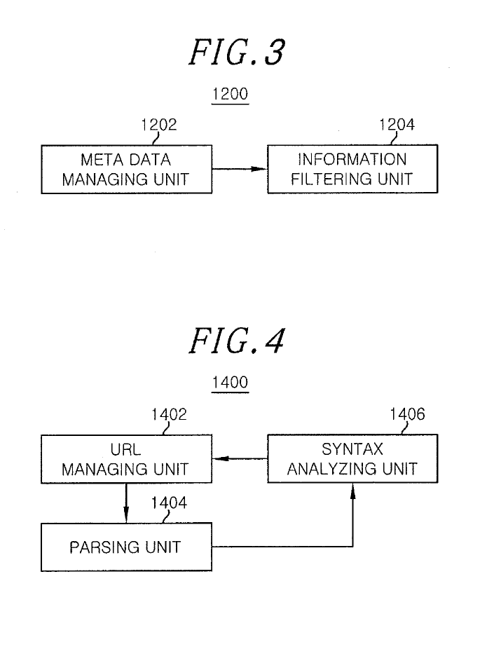

FIG. 3 illustrates a specific block diagram of a profile managing unit of the profile managing unit of FIG. 2.

The profile managing unit 1200 includes a meta data managing unit 1202 and an information filtering unit 1204.

The meta data managing unit 1202 can manage factors constituting the access monitoring profile information and generate a keyword used for searching for the network information (e.g., web page etc.). Of course, the factors constituting the access monitoring profile information can be added or deleted by the manager.

The information filtering unit 1204 can categorize and group the network information (web page information) which is relating to the visitor information or not relating to the visitor information with information analyzed by the preprocessing unit 1204.

In addition, the information filtering unit 1204 can extract data needed for constituting a profile from the grouped network information (web page information).

FIG. 4 depicts a specific block diagram of the preprocessing unit 1400. The preprocessing unit 1400 can include uniform resource locator (URL) managing unit 1402, a parsing unit 1404 and a syntax analyzing unit 1406 etc.

The URL managing unit 1402 can manage the network information (e.g., the URL information of the web page information) which is searched for by the information searching unit 1300.

The URL managing unit 1402 can determine whether the URL corresponds to the access monitoring profile information or not.

The parsing unit 1404 can extract a text-type data by parsing the network information, e.g., a hyper text markup Language (HTML), an extensible markup language (XML) etc.

The syntax analyzing unit 1406 can remove a stopword from the text-type data extracted from the parsing unit 1404 and perform a morpheme analysis.

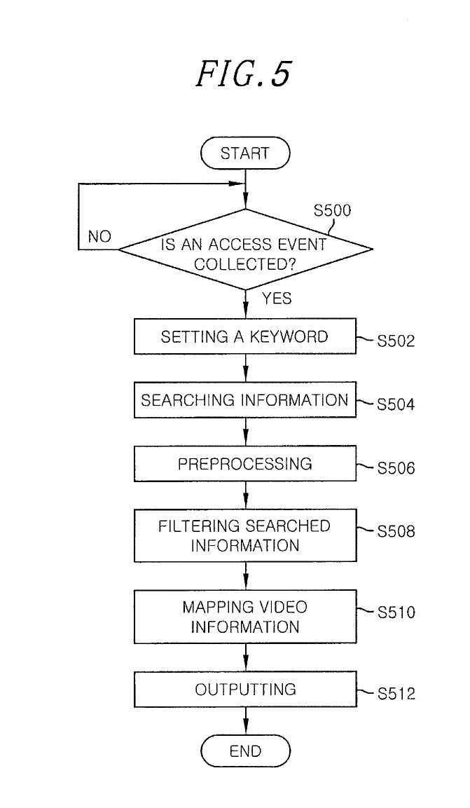

Hereinafter, an intelligent access monitoring method according to the embodiment of the present invention, specifically an access monitoring process by the access monitoring apparatus 100 will be explained with reference to the flow chart of FIG. 5.

As shown in FIG. 5, when the access event is generated by the access control apparatus 10, the access event information can be collected by the access event collecting unit 1100 of the access monitoring apparatus 100 in step S500. The access event information can be, e.g., the smart card tag information.

The access event information collected by the access event collecting unit 1100 can be provided to the profile managing unit 1200. The profile managing unit 1200 can generate a keyword for the network information of the visitor based on the access event information, e.g., a keyword relating to the name, the occupation and the rap sheet of the visitor in step S502.

The keyword generated by the profile managing unit 1200 can be provided to the information searching unit 1300 and the information searching unit 1300 can search for the network information, e.g., web pages by using the keywords in step S504.

Thereafter, the preprocessing unit 1400 can perform a preprocessing by removing the stopword which a user is not interested in, e.g., a tag such as unnecessary HTML and XML, etc. and a postposition and performing syntax analysis in order to extract necessary information for an access monitoring from the network information searched by the information searching unit 1300 in step S506.

The result of the preprocessing of the preprocessing unit 1400 can be provided to the profile managing unit 1200 and the profile managing unit 1200 can perform a grouping process where a web page relating to the access monitoring profile information and a web page not relating to the access monitoring profile information is categorized by using the result of the preprocessing, e.g., data extracted from the network information. Then, the profile managing unit 1200 can perform an information filtering process where a data for constituting the profile is extracted in step S508.

Thereafter, the access monitoring unit 1500 can generate the access monitoring profile information corresponding to the visitor information filtered by the profile managing unit 1200 and provide a mapping information where the generated access monitoring profile information is mapped with the location information and the video information of the video security apparatus 12 in step S510. Specifically, the access monitoring unit 1500 can collect a meta data and corresponding values, generate the access monitoring profile information and map the access monitoring profile information with the location information and the video information of the video security apparatus 12.

The mapped access monitoring profile information, the location information and the video information can be processed to be displayed on the 3D picture of a specific building and thus, an intuitive access monitoring environment can be provided and a rapid and high-level security environment can be made by providing the profile information of the visitor additionally when monitoring the visitor.

Meanwhile, the intelligent access monitoring method according to the embodiment of the present invention can be achieved by providing all kinds of storage mediums storing a program code of software realizing a function of each above-described embodiment to a computer so that the computer reads out the program code stored in the storage medium to execute it.

As described above, according to the embodiment of the present invention, the accuracy and the security level can be raised by collecting and analyzing the additional network information for the visitor through a web with the access event information of the visitor entering a building or a industry facility, e.g., a smartcard tag information, and providing the profile information of the visitor. In addition, the security state can be recognized intuitively by mapping the video information of the visitor with the 3D building using the profile information and the location information of the video security system.

While the invention has been shown and described with respect to the embodiments, it will be understood by those skilled in the art that various changes and modification may be made without departing from the scope of the invention as defined in the following claims.

What is claimed is:

1. A system for intelligent access monitoring, comprising:
an access control apparatus for detecting and managing an access of a visitor, the access control apparatus generating a access event information when detecting the access;
a video security apparatus for managing an video information and a location information of the visitor; and
an access monitoring apparatus for receiving the access event information, the video information and the location information via a network, generating a access monitoring profile information based on the access event information, and generating a mapping information where the access monitoring profile information is mapped with the video information and the location information.

2. The system of claim 1, further comprising a access monitoring database in which the video information and the location information are stored.

3. The system of claim 1, wherein the mapping information is a mapping information where the access monitoring information is mapped with the video information by using the location information.

4. The system of claim 1, wherein the mapping information is processed to be displayed on a 3D building.

5. The system of claim 1, wherein a data mining technique is applied to the access monitoring information in order to provide an additional information of the visitor by collecting and analyzing a network information.

6. An intelligent access monitoring apparatus, comprising:
an access event collecting unit for receiving an access event information from an access control apparatus via a network;
a profile managing unit for generating a keyword for a network information search, categorizing and grouping the network information repeatedly according to a result of the network information search;
an information searching unit for searching for the network information by using the keyword generated by the profiling managing unit;
a preprocessing unit for performing a preprocessing for extracting an information relating to a visitor information from the network information which is searched for by the information searching unit and providing the profile managing unit with a result of the preprocessing; and
an access monitoring unit for generating an access monitoring profile information corresponding to the visitor information filtered by the profile managing unit and providing a mapping information where the generated access monitoring profile information is mapped with the video information and the location information of a video security apparatus.

7. The apparatus of claim 6, wherein the profile managing unit performs a grouping and a filtering a visitor information having a same name as the visitor information by categorizing and grouping the network information repeatedly.

8. The apparatus of claim 6, wherein the mapping information is processed to be displayed on a 3D building.

9. The apparatus of claim 6, wherein the profile managing unit includes a meta data managing unit for managing factors constituting the access monitoring profile information and generating the keyword; and a information filtering unit for categorizing and grouping the network information relating to the visitor information or not relating to the visitor information through an information analyzed by the preprocessing unit.

10. The apparatus of claim 9, wherein the information filtering unit extracts data from the grouped network information in order to form a profile.

11. The apparatus of claim 6, wherein the preprocessing unit includes a URL managing unit for managing an URL information of the network information searched by the information searching unit; a parsing unit for extracting a text-type data by parsing a HTML information or a XML information of the network information; and a syntax analyzing unit for removing a stopword from the text-type data extracted by the parsing unit.

12. The apparatus of claim 11, wherein the URL managing unit determines whether the URL information corresponds to the access monitoring profile information or not.

13. The apparatus of claim 11, wherein the syntax analyzing unit performs a morpheme analysis in a smallest unit of meaning.

14. The apparatus of claim 6, wherein the network information includes a web page information relating an access monitoring by the keyword.

15. A method for providing an intelligent access monitoring, comprising:
receiving an access event information from an access control apparatus;
receiving a video information and a location information of a visitor form a video security apparatus;
generating an access monitoring profile information based on the received access event information; and
providing a mapping information where the generated access monitoring information is mapped with the received video information and location information.

16. The method of claim 15, wherein the mapping information is a mapping information where the access monitoring information is mapped with the video information by using the location information.

17. The method of claim 15, wherein the mapping information is processed to be displayed on a 3D building.

18. The method of claim 15, wherein a data mining technique is applied to the access monitoring information in order to provide an additional information of the visitor by collecting and analyzing a network information.

19. The method of claim 18, wherein the network information includes a web page information.
